(19) United States
(12) Patent Application Publication
(10) Pub. No.: US 2026/0242155 A1
(43) Pub. Date: Aug. 20, 2026

(54) LOWER CARRIER ROLLER DEVICE FOR BELT CONVEYOR HAVING SWEEPING AND CLEANING FUNCTIONS AND BELT CONVEYOR

(71) Applicant: Baoshan Iron & Steel Co., Ltd., Shanghai (CN)

(72) Inventors: Ye Ding, Shanghai (CN); Ruimin Wu, Shanghai (CN); Bin Yang, Shanghai (CN); Chen Shen, Shanghai (CN)

(21) Appl. No.: 18/869,723

(22) PCT Filed: May 8, 2023
(86) PCT No.: PCT/CN2023/092712

§ 371 Date: Nov. 26, 2024

(30) Foreign Application Priority Data
May 27, 2022 (CN) 202210591040.2

(51) Int. Cl. B65G 45/18; B65G 39/073

(52) U.S. Cl. CPC B65G 45/18; B65G 39/073

(57) ABSTRACT

The present disclosure discloses a lower carrier roller device for a belt conveyor having sweeping and cleaning functions, which comprises a lower carrier roller assembly and a sweeping roller brush assembly arranged on one side of the lower carrier roller assembly, wherein the sweeping roller brush assembly is fit with the lower carrier roller assembly; the lower carrier roller assembly comprises a lower carrier roller, which is arranged in a running direction of a return belt of the belt conveyor; and a surface of the lower carrier roller is configured to a rhombic grid shape; the sweeping roller brush assembly comprises a roller brush shaft and a roller brush arranged on the roller brush shaft; the roller brush shaft is arranged parallel to and below the lower carrier roller, and the roller brush is fit with the surface of the lower carrier roller. The present disclosure also discloses a belt conveyor comprising the lower carrier roller device for a belt conveyor. According to the present disclosure, the lower carrier roller has sweeping and cleaning functions while supporting the return belt, and direct contact between a traditional sweeping mechanism and a belt is avoided, thereby reducing abrasion to the surface of the belt conveyor.

### TECHNICAL FIELD

The disclosure relates to industrial material transportation equipment, more specifically, relates to a lower carrier roller device for a belt conveyor having sweeping and cleaning functions, and a belt conveyor.

### BACKGROUND ART

Belt conveyor (also called ribbon conveyor or band conveyor) has the characteristics of high efficiency and low cost, and is widely used in mine, dock, coal, electric power generation and metallurgy industries. Sweeper of the existing belt conveyor mainly adopts the form of mechanical scrapers or the form of electric roller brushes. The form of mechanical scrapers adopts spring or counterweight pre-tightening force to attach the scraper to the belt surface for scraping off the bonded raw materials. The form of electric roller brush adopts a motor to drive a cylindrical nylon brush, so that the brush tip is in contact with the surface of the conveyor belt, thereby removing the adherents affixed to the surface of the belt. Due to various reasons such as the rigidity and length of the scraper and the elastic belt, the sweeper in the form of a mechanical scraper cannot ensure full contact between the scraper and the belt surface along the entire length of the belt width direction during use, resulting in incomplete cleaning. Due to the factors such as alternating contact and vibration of belt and carrier roller during the subsequent return process, the bonded raw materials may fall under the belt. Therefore, sometimes these two types of sweepers are used together. However, both the above two types of cleaners have a disadvantage that the sweepers are in direct contact with the belt and constantly rub against the belt surface, which can easily cause abrasion on the belt surface and reduction of the service life of the belt.

### SUMMARY OF THE INVENTION

In view of the above-mentioned defects in the prior art, the objects of the present disclosure are to provide a lower carrier roller device for belt convey or having sweeping and cleaning functions, and a belt conveyor, so that the lower carrier roller has sweeping and cleaning functions while supporting the return belt, and direct contact between a traditional sweeping mechanism and a belt is avoided, thereby reducing abrasion to the surface of the belt conveyor.

In order to achieve the above objects, the present disclosure adopts the following technical solutions.

In one aspect, provided is a lower carrier roller device for belt conveyor having sweeping and cleaning functions, comprising a lower carrier roller assembly and a sweeping roller brush assembly arranged on one side of the lower carrier roller assembly, wherein the sweeping roller brush assembly is fit with the lower carrier roller assembly;
wherein the lower carrier roller assembly comprises a lower carrier roller, which is arranged along a running direction of a return belt of the belt conveyor, and wherein a surface of the lower carrier roller is configured to a rhombic grid shape;
wherein the sweeping roller brush assembly comprises a roller brush shaft and a roller brush arranged on the roller brush shaft, the roller brush shaft is arranged parallel to and below the lower carrier roller, and the roller brush is fit with the surface of the lower carrier roller.

Preferably, the rhombic grid shape is composed of multiple sets of arc grooves, the multiple sets of arc grooves are evenly spaced along the lower carrier roller, and the arc grooves are arranged in a clockwise and counterclockwise spiral pattern.

Preferably, the arc grooves are configured as ⅛ to ½ of a circle, with a diameter of ≤5 mm.

Preferably, the roller brush is composed of multiple bundles of bristles, with the diameter of the bristles being smaller than the diameter of the arc grooves.

Preferably, the roller brush shaft has a hollow structure and has a plurality of ventilation holes on its surface.

Preferably, the lower roller has a spindle-shaped structure, with the diameter gradually decreasing from the middle position toward both ends.

Preferably, the lower carrier roller is made of hydrophobic material(s).

Preferably, the sweeping roller brush assembly further includes a driving device for driving the roller brush shaft to rotate.

In another aspect, provided is a belt conveyor, comprising one or more stages of the lower carrier roller device for belt conveyor having sweeping and cleaning functions, wherein the one or more stages of the lower carrier roller device for belt conveyor are arranged along the running direction of the return belt of the belt conveyor.

Preferably, the multiple stages of the lower carrier roller device for belt conveyor are arranged in sequence along the running direction of the return belt of the belt conveyor;
along the running direction of the return belt of the belt conveyor, the spacing of the arc grooves of the lower carrier roller device for belt conveyor gradually decreases;
along the running direction of the return belt of the belt conveyor, the diameter of the arc grooves of the lower carrier roller device for belt conveyor gradually decreases.

The disclosure provides a lower carrier roller device for belt conveyor having sweeping and cleaning functions and belt conveyor. Through the rhombic grid shaped arc grooves on the surface of the lower carrier roller and the friction between the lower roller and the return belt, the adhesive materials attached to the surface of the lower carrier roller is ground into fine particles and embedded in the arc grooves, thereby destroying their integrity, cutting them into blocks, and making it easier for them to fall off the surface of the return belt. Furthermore, a sweeping roller brush is used to remove the adhesive materials from the surface of the lower carrier roller, avoiding direct contact between the sweeping mechanism and the belt surface, thereby reducing the abrasion of the belt. The spindle-shaped design of the lower carrier roller ensures full contact between the middle belt which has the most contact with the transported materials and the lower carrier roller, guaranteeing the quality of sweeping and cleaning.

### DESCRIPTION OF THE DRAWINGS

FIG. 1 is a schematic structural diagram of the lower carrier roller device for belt conveyor of the present disclosure.

FIG. 2 is a schematic side view of the lower carrier roller device for belt conveyor of the present disclosure.

FIG. 3 is a schematic structural diagram of the lower carrier roller in the lower carrier roller device for belt conveyor of the present disclosure.

FIG. 4 is a schematic diagram of the spindle-shaped structure of the lower carrier roller in the lower carrier roller device for belt conveyor of the present disclosure.

FIG. 5 is a schematic cross-sectional view of an arc groove on the surface of the lower carrier roller in the lower carrier roller device for belt conveyor when it is configured as ½ of a circle.

FIG. 6 is a schematic cross-sectional view of an arc groove on the surface of the lower roller in the lower carrier roller device for belt conveyor when it is configured as ⅛ of a circle.

FIG. 7 is a schematic structural diagram of the sweeping roller brush assembly in the lower carrier roller device for belt conveyor of the present disclosure.

FIG. 8 is a schematic diagram of the arrangement of the driving device in the lower carrier roller device for belt conveyor of the present disclosure.

### DETAILED DESCRIPTION

In order to better understand the above technical solutions of the present disclosure, the technical solutions of the present disclosure are further described below in conjunction with the accompanying drawings and examples.

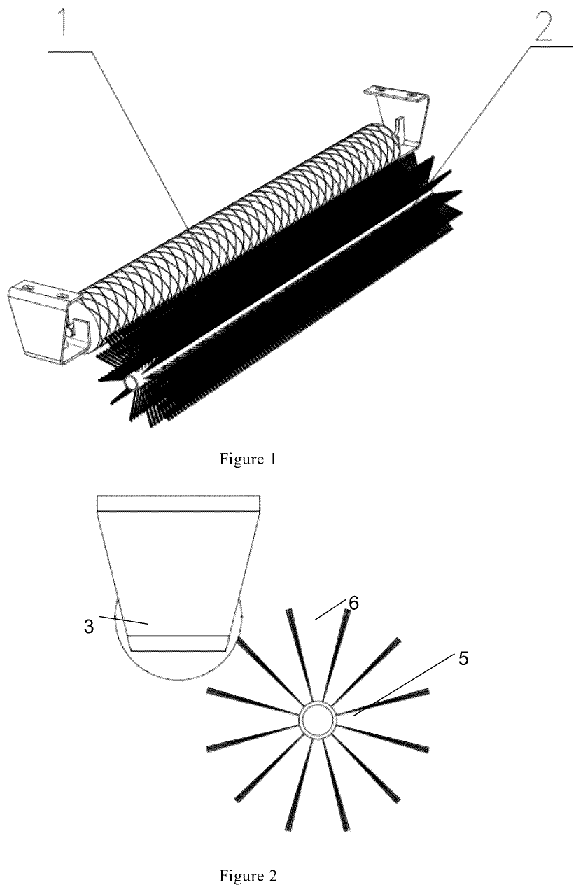

As shown in FIG. 1 and FIG. 2, the disclosure provides a lower carrier roller device for belt conveyor having sweeping and cleaning functions, which comprises a lower carrier roller assembly 1 and a sweeping roller brush assembly 2 arranged on one side of the lower carrier roller assembly 1 and cooperated with the lower carrier roller assembly 1.

The lower carrier roller assembly 1 comprises a lower carrier roller 3 arranged along the running direction of a return belt of the belt conveyor, and the surface of the lower carrier roller is configured to a rhombic grid shape.

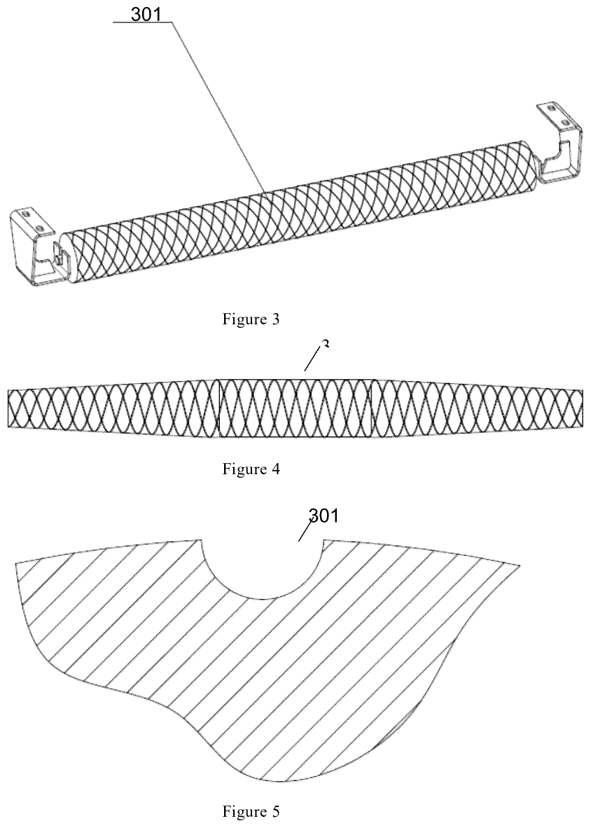

The sweeping roller brush assembly 2 comprises a roller brush shaft 5 arranged parallel to and below the lower carrier roller 3 and a roller brush 6 arranged on the roller brush shaft 5. The roller brush 6 is distributed circumferentially along the roller brush shaft 5. The roller brush 6 is cooperated with the surface of the lower carrier roller 3. As shown in FIG. 3 to FIG. 6, the rhombic grid shape is composed of multiple sets of arc grooves 301, and the arc grooves 301 are evenly spaced in a clockwise and counterclockwise spiral pattern along the surface of the lower carrier roller 3.

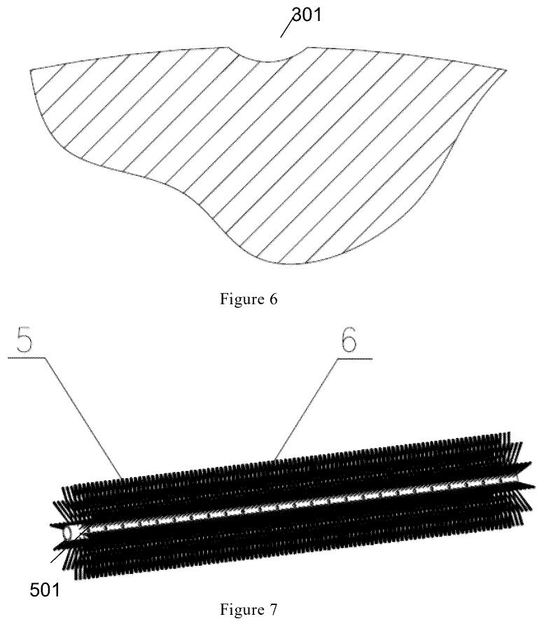

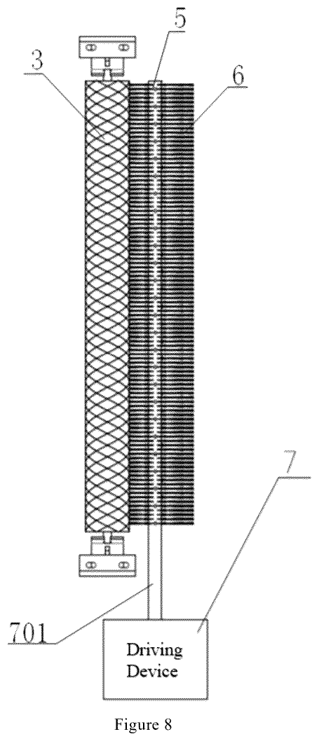

Referring to FIG. 5 and FIG. 6, FIG. 5 shows a schematic cross-sectional view of the arc grooves being ½ of a circle, and FIG. 6 shows a schematic cross-section of the arc grooves being 1/8 of a circle. The arc grooves 301 are configured as ⅛ to ½ of a circle, and the diameter of the arc grooves 301 are ≤5 mm.

The lower carrier roller 3 has a spindle-shaped structure, with the diameter gradually decreasing from the middle position toward both ends to ensure that the adhesive materials in the middle of the return belt is fully in contact with the surface of the lower carrier roller 3.

The lower carrier roller 3 is made of hydrophobic materials to reduce the adhesion of raw materials.

As shown in FIG. 7, the roller brush 6 is composed of multiple bundles of bristles, and the diameter of the bristles is smaller than the diameter of the arc grooves 301.

The roller brush shaft 5 has a hollow structure, and a plurality of ventilation holes 501 are provided on its surface to ventilate the inside of the roller brush shaft 5 for purging operations.

With the rhombic grid shaped arc grooves 301 on the surface of the lower carrier roller 3 in the lower carrier roller device for belt conveyor of the present disclosure, the adhesive materials attached to the surface of the lower carrier roller is ground into fine particles and embedded in the arc grooves by utilizing the friction between the lower roller and the return belt, thereby destroying their integrity and cutting them into blocks, making it easier for them to fall off the surface of the return belt. Furthermore, a roller brush 6 of the sweeping roller brush assembly is used to remove the adhesive materials from the surface of the lower carrier roller, avoiding direct contact between the sweeping mechanism and the return belt surface, thereby reducing the abrasion of the return belt.

The rotation of the sweeping roller brush assembly 2 may be powered by the rotation of the lower carrier roller 3, which drives the rotation of the roller brush shaft 5, without the need for an external power source. Alternatively, as shown in FIG. 7, in order to further enhance its sweeping effect, the sweeping roller brush assembly 2 also comprises a driving device 7, with the output end 701 of the driving device 7 connected to the end of the roller brush shaft 5, providing a power source for the sweeping roller brush assembly 2 to drive the rotation of the roller brush shaft 5.

The disclosure also provides a belt conveyor, which comprises one or more stages of the lower carrier roller device for belt conveyor having sweeping and cleaning functions arranged in the running direction of the return belt of the belt conveyor.

The multiple stages of the lower carrier roller device for belt conveyor installed in sequence in the running direction of the return belt of the belt conveyor.

Along the running direction of the return belt of the belt conveyor, the spacing of the arc grooves 301 of the lower carrier roller device for belt conveyor gradually decreases, that is, along the running direction of the return belt of the belt conveyor, the spacing of the arc grooves 301 of the lower carrier roller device for belt conveyor in the next stage is smaller than that of the previous stage. Along the running direction of the return belt of the belt conveyor, the diameter of the arc grooves 301 of the lower carrier roller device for belt conveyor gradually decreases, that is, along the running direction of the return belt of the belt conveyor, the diameter of the arc grooves 301 of the lower carrier roller device for belt conveyor in the next stage is smaller than that of the previous stage.

Along the running direction of the return belt of the belt conveyor, the bonded transport materials undergo multi-stage cleaning to ensure the cleaning effect. Additionally, the diameter and spacing of the arc grooves 301 of the lower carrier roller device for belt convey in the next stage are smaller than those of the previous stage, resulting in increasingly thorough cleaning.

Those of ordinary skill in the technical field should recognize that the above embodiments are intended to illustrate the present disclosure and are not used to limit the present disclosure. Any variations or modifications of above embodiments that fall within the substantive spirit of the present invention will be covered by the claims of the invention.

1. A lower carrier roller device for belt conveyor having sweeping and cleaning functions, comprising a lower carrier roller assembly and a sweeping roller brush assembly arranged on one side of the lower carrier roller assembly, wherein the sweeping roller brush assembly is fit with the lower carrier roller assembly;
wherein the lower carrier roller assembly comprises a lower carrier roller, which is arranged along a running direction of a return belt of the belt conveyor, and wherein a surface of the lower carrier roller is configured to a rhombic grid shape;
wherein the sweeping roller brush assembly comprises a roller brush shaft and a roller brush arranged on the roller brush shaft, the roller brush shaft is arranged parallel to and below the lower carrier roller, and the roller brush is fit with the surface of the lower carrier roller.

2. The lower carrier roller device for belt conveyor according to claim 1, wherein the rhombic grid shape is composed of multiple sets of arc grooves, the multiple sets of arc grooves are evenly spaced along the lower carrier roller, and the arc grooves are arranged in a clockwise and counterclockwise spiral pattern.

3. The lower carrier roller device for belt conveyor according to claim 2, wherein the arc grooves are configured as ⅛ to ½ of a circle, with a diameter of ≤5 mm.

4. The lower carrier roller device for belt conveyor according to claim 3, wherein the roller brush is composed of multiple bundles of bristles, with the diameter of the bristles being smaller than the diameter of the arc grooves.

5. The lower carrier roller device for belt conveyor according to claim 1, wherein the roller brush shaft has a hollow structure and has a plurality of ventilation holes on its surface.

6. The lower carrier roller device for belt conveyor according to claim 1, wherein the lower roller has a spindle-shaped structure, with the diameter gradually decreasing from the middle position toward both ends.

7. The lower carrier roller device for belt conveyor according to claim 1, wherein the lower carrier roller is made of hydrophobic material(s).

8. The lower carrier roller device for belt conveyor according to claim 1, wherein the sweeping roller brush assembly further includes a driving device for driving the roller brush shaft to rotate.

9. A belt conveyor comprising one or more stages of the lower carrier roller device for belt conveyor according to claim 1, wherein the one or more stages of the lower carrier roller device for belt conveyor are arranged along the running direction of the return belt of the belt conveyor.

10. The belt conveyor according to claim 9, wherein the multiple stages of the lower carrier roller device for belt conveyors are arranged in sequence along the running direction of the return belt of the belt conveyor;
along the running direction of the return belt of the belt conveyor, the spacing of the arc grooves of the lower carrier roller device for belt conveyor gradually decreases;
along the running direction of the return belt of the belt conveyor, the diameter of the arc grooves of the lower carrier roller device for belt conveyor gradually decreases.

11. The belt conveyor according to claim 9, wherein the rhombic grid shape is composed of multiple sets of arc grooves, the multiple sets of arc grooves are evenly spaced along the lower carrier roller, and the arc grooves are arranged in a clockwise and counterclockwise spiral pattern.

12. The belt conveyor according to claim 11, wherein the arc grooves are configured as ⅛ to ½ of a circle, with a diameter of ≤5 mm.

13. The belt conveyor according to claim 12, wherein the roller brush is composed of multiple bundles of bristles, with the diameter of the bristles being smaller than the diameter of the arc grooves.

14. The belt conveyor according to claim 9, wherein the roller brush shaft has a hollow structure and has a plurality of ventilation holes on its surface.

15. The belt conveyor according to claim 9, wherein the lower roller has a spindle-shaped structure, with the diameter gradually decreasing from the middle position toward both ends.

16. The belt conveyor according to claim 9, wherein the lower carrier roller is made of hydrophobic material(s).

17. The belt conveyor according to claim 9, wherein the sweeping roller brush assembly further includes a driving device for driving the roller brush shaft to rotate.
